(19) United States
(12) Patent Application Publication
(10) Pub. No.: US 2022/0331198 A1
(43) Pub. Date: Oct. 20, 2022

(54) PERSONAL MASSAGE DEVICE

(71) Applicant: CARIC, Inc., Boston, MA (US)

(72) Inventors: Constantin Dietrich, Miami, FL (US); Andreas Bergmann, Miami Beach, FL (US)

(21) Appl. No.: 17/720,524

(22) Filed: Apr. 14, 2022

Related U.S. Application Data
(60) Provisional application No. 63/174,788, filed on Apr. 14, 2021.

(51) Int. Cl. A61H 19/00; A61H 23/02

(52) U.S. Cl. CPC A61H 19/34; A61H 23/02; A61H 2201/169; A61H 2201/123; A61H 2201/0207

(57) ABSTRACT

A personal massage device is provided that includes an elongated housing having a first end and a second end. A vibrating head is coupled to the housing below the first end. The vibrating head can include an annular projection, an annular depression positioned within the annular projection and depressed below the annular projection, and a convex projection positioned within the annular depression, the convex projection extending above the annular depression. A motor is coupled to the convex projection and is operable to cause the convex projection to vibrate. The device includes a control unit to control the motor to generate a number of vibration patterns. One or more control inputs may be included to allow a user to provide input to the control unit for selecting a desired vibration pattern.

### CROSS REFERENCE TO RELATED APPLICATIONS

This application claims benefit under 35 U.S.C. 119(e) to U.S. Provisional Patent Application Ser. No. 63/174,788, entitled, “Personal Massage Device” and filed Apr. 14, 2021, the contents of which are incorporated herein in their entirety for all purposes.

### FIELD OF THE DISCLOSURE

This patent specification relates to the field of massage devices. More specifically, this patent specification relates to a personal massage device that is configured to mimic the sensation of human touch to the body.

### BACKGROUND

Massage has been used for many years to soothe or eliminate muscle and joint pains, or simply to relax and refresh a person. Acupressure is one ancient massage technique that is based upon manual application of pressure (using a hand, elbow, or other body part) to the body for a period of time to promote healing and other positive benefits. Fairly recently, personal massage devices have been introduced to the marketplace to enable unskilled persons to give and receive a comforting massage. Due to the uniqueness of the human body and the desire to provide and receive massage experiences from devices that mimic the sensation of human touch to the body, an ever-present need exists for novel massage devices that are configured to mimic the sensation of human touch to the body.

### BRIEF SUMMARY

A personal massage device is provided which may be used to mimic the sensation of human touch to the body. In some implementations, the device includes an elongated housing having a first end and a second end. The second end may be configured with a tapered tip that may be slightly angled or curved towards the first end. A vibrating head may be coupled to the housing below the first end. The vibrating head may comprise an annular projection which may extend generally perpendicularly away from the housing relative to the first and second ends. An annular depression may be positioned within the annular projection and depressed below the annular projection. A convex projection may be positioned within the annular depression, and the convex projection may extend above the annular depression. In some implementations, the annular projection, annular depression, and convex projection may be generally concentric with each other. A motor may be coupled to the vibrating head, and the motor may be operable to cause the vibrating head to vibrate. A control unit may be configured to control the motor to generate a number of vibration patterns, and one or more control inputs may be manipulated by a user to provide input to the control unit for selecting a desired vibration pattern.

In further aspects, there is provided a personal massage device comprising an elongated housing having a first end and a second end; a vibrating head coupled to the housing below the first end, the vibrating head comprising an annular projection that extends away from the housing relative to the first and second ends, an annular depression positioned within the annular projection and depressed below the annular projection, and a convex projection positioned within the annular depression and extending above the annular depression; a motor coupled to the convex projection of the vibrating head so as to cause the convex projection to extend along a vibration axis to a position that is beyond the annular projection; and a control unit configured to operate the motor to generate a number of vibration patterns.

In some implementations, there is provided a personal massage device comprising an elongated housing having a first end and a second end; a vibrating head coupled to the housing below the first end, the vibrating head comprising an annular projection that extends away from the housing relative to the first and second ends and a convex projection positioned within the annular projection; a motor coupled to the convex projection of the vibrating head so as to cause the convex projection to extend along a vibration axis; and a control unit configured to operate the motor to generate a number of vibration patterns.

### BRIEF DESCRIPTION OF THE DRAWINGS

The disclosure may be more completely understood in consideration of the accompanying drawings, in which:

FIG. 1 depicts a side perspective view of an example of a personal massage device according to various implementations described herein.

FIG. 2 illustrates a front elevation view of an example of a personal massage device according to various implementations described herein.

FIG. 3 shows a rear elevation view of an example of a personal massage device according to various implementations described herein.

FIG. 4 depicts a side elevation view of an example of a personal massage device according to various implementations described herein.

FIG. 5 illustrates a top plan view of an example of a personal massage device according to various implementations described herein.

FIG. 6 shows a bottom plan view of an example of a personal massage device according to various implementations described herein.

FIG. 7 depicts a perspective exploded view of an example of a personal massage device according to various implementations described herein.

FIG. 8 illustrates a sectional elevation view of an example of a personal massage device according to various implementations described herein.

FIG. 9 illustrates a side elevation view of an example of a personal massage device in use according to various implementations described herein.

FIG. 10 illustrates a side elevation view of an example of a personal massage device in use according to various implementations described herein.

The figures are not necessarily to scale. Like numbers in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific implementations. It is to be understood that other implementations are contemplated and may be made without departing from the scope or spirit of the present disclosure. The following detailed description, therefore, is not to be taken in a limiting sense.

A new personal massage device is discussed herein. In the following description, for purposes of explanation, numerous specific details are set forth in order to provide a thorough understanding of the present disclosure. It will be evident, however, to one skilled in the art that the present disclosure may be practiced without these specific details. The present disclosure is to be considered as an exemplification and is not intended to limit the disclosure to the specific implementations illustrated by the figures or description below.

In some implementations, personal massage devices described herein can be particularly useful for application to sensitive tissues of the body. For purposes of illustration, some concepts will be described with reference to a personal massage device for use with the clitoris. The clitoris is the human female's most sensitive erogenous zone and generally the primary anatomical source of human female sexual pleasure. In humans, the visible portion of the clitoris is the glans, which is estimated to have approximately 8,000 sensory nerve endings. Due to the glans' high sensitivity, direct stimulation to this tissue is not always pleasurable; therefore, some concepts provide a massage device that mimics human touch by balancing intensity (taps per minute) with vibration amplitude (stroke length, measured in mm). Discussion of benefits and features of some concepts will be readily apparent with respect to application to the clitoris. However, it will be appreciated that some concepts can be applied to other sensitive tissues of a user's body as well. For example, devices in accordance with some concepts can be useful to treat neuropathic pain, by applying a targeted, soft touch to areas of the body exhibiting symptoms of neuropathy.

In a general sense, some concepts provide a personal massage device comprising an unique vibrating head that comprises a convex projection that extends along a vibration axis to contact a tissue. The vibrating head can include an annular projection and annular depression that surround the convex projection. In some aspects, the annular projection, annular depression, and convex projection are concentric. The convex projection can be sized to approximate the tissue to be treated (e.g., the clitoris) with the personal massage device. The convex projection of the vibrating head is directly coupled with a motor that provides adjustable vibration to the convex projection. The motor can provide vibration along a vibration axis. In some implementations, the vibrating head further comprises an annular buttress. The unique arrangement and configuration of these elements can provide a personal massage device that mimics human touch by utilizing some concepts of acupressure. Further, some devices include a vibrating head that is configured in a manner to provide targeted touch to a user.

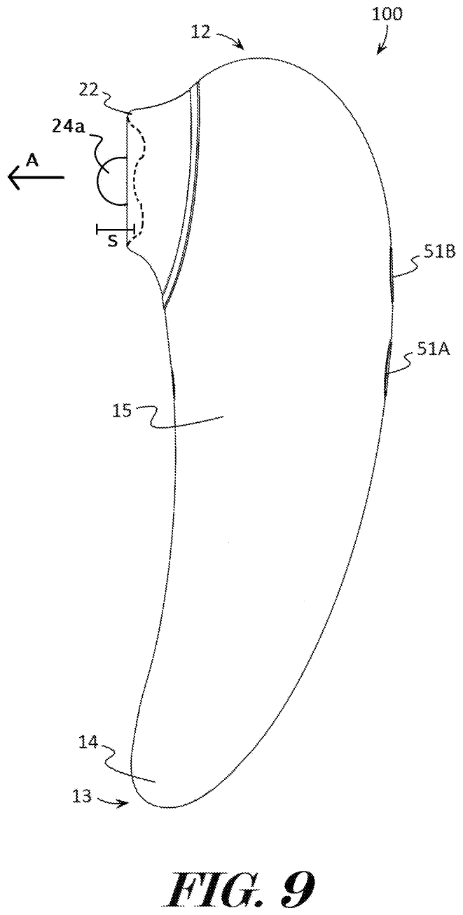

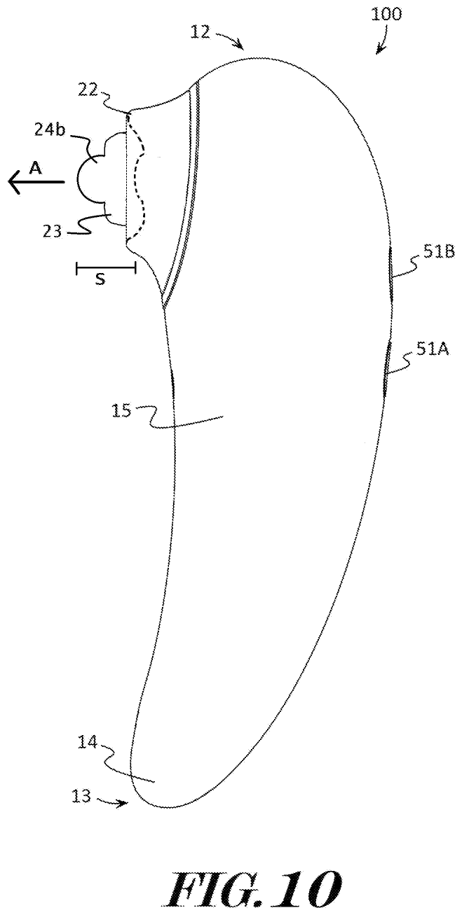

In accordance with some concepts, massage devices described herein can provide an adjustable touch profile without requiring substitution of different component parts. As used herein, the “touch profile” of the device is the configuration (shape) of the vibrating head that extends from the device to contact a user. The touch profile is thus impacted by the portions of the vibrating head that contact the user. For example, in some implementations the touch profile can comprise a rounded protrusion (wherein the convex projection contacts the user), while in other implementations, the touch profile can comprise a rounded protrusion having a shoulder (wherein the convex projection and annular depression contact the user). In these aspects, the configuration of vibrating head components, and the manner in which the convex projection of the vibrating head is attached to the motor, can allow a user to change the touch profile of the device without having to substitute a different component (i.e., a separate vibrating head) to the device. The touch profile can result from extension of components of the vibrating head during use, as illustrated in FIGS. 9 and 10. In these aspects, the flexibility of the vibrating head components, and the manner in which the vibrating head is connected to the motor, can provide the ability to change the touch profile of the device on demand. In some implementations, the vibrating head can be configured in a manner such that the vibrating head provides the same touch profile at rest and in use. In these aspects, the vibrating head is preconfigured with a desired touch profile that resembles, for example, the profiles illustrated in FIGS. 9 and 10.

In accordance with some concepts, vibrational energy is used to apply intermittent touching of a clitoris in a gentle manner. In some aspects, personal massage devices can provide user control over the intensity (speed), pattern, stroke length, and touch profile of the vibrating head of the device.

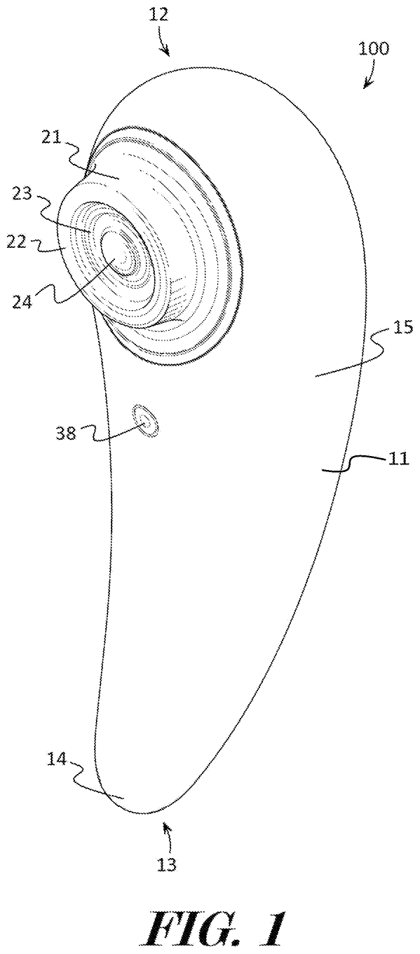

The present disclosure will now be described by example and through referencing the appended figures representing various implementations. FIGS. 1-8 illustrate an example of a personal massage device (“the device”) 100 according to various implementations. Turning to FIG. 1, in general aspects, the device 100 may include an elongated housing 11 having a first end 12 and a second end 13. Optionally, the second end 13 may be configured with a tapered tip 14 that may be slightly angled or curved towards the first end 12. A vibrating head 21 may be coupled to the housing 11 below the first end 12. The vibrating head 21 may comprise an annular projection 22 which may extend generally perpendicularly away from the housing 11 relative to the first 12 and second 13 ends. In some implementations, the vibrating head 21 may not extend perpendicularly away from the housing 11 relative to the first end 12 and the second end 13, but may be provided at a different angle relative to the housing. In some implementations, the vibrating head 21 may be positioned below the surface of the housing 11 relative to the first end 12 and the second end 13. An annular depression 23 may be positioned within the annular projection 22 and depressed below the annular projection 22. A convex projection 24 may be positioned within the annular depression 23, and the convex projection 24 may extend above the annular depression 23. In some implementations, the convex projection 24 does not extend above the annular depression 23. For example, the convex projection 24 may be substantially flush with the annular depression 23 in some implementations. In some implementations, the convex projection 24 may be positioned below the annular depression 23. In some implementations, the convex projection 24 may be positioned between the first end 12 and the second end 13 without the annular projection 22 or the annular depression 23. In some implementations, the convex projection 24 may sit flush or substantially flush with the housing. As illustrated in FIG. 1, the device 100 can include a power input plug member 38.

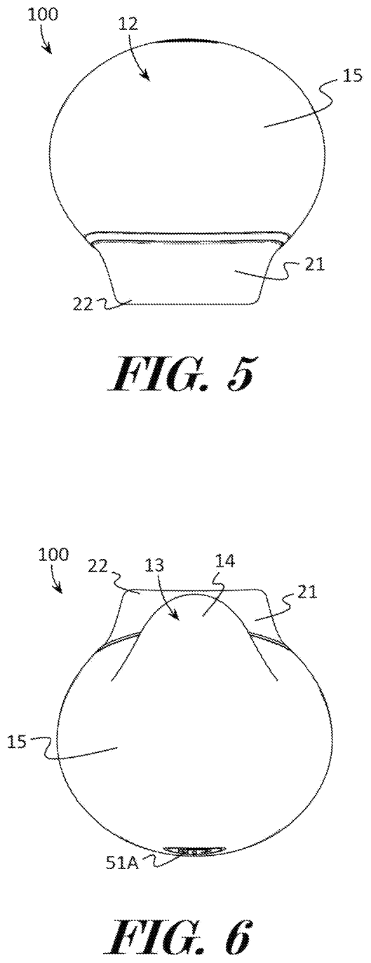

The device 100 may comprise a housing 11 that may be configured in any shape and size. In some implementations, the device 100 may include an elongated housing 11 having a first end 12 and a second end 13, and both ends 12, 13, may be generally rounded so as to not have any sharp angles or edges as shown in FIGS. 5 and 6. In further implementations, a first end 12 may be generally larger than a second end 13. Optionally, a second end 13 may be configured with a tapered tip 14 that may be slightly angled or curved towards the first end 12. A tapered tip 14 may be generally rounded and may be smaller than the first end 12. These features of the tapered tip 14 can provide an ergonomic device that is comfortably held in one hand during use. In some implementations, the tapered tip 14 is not angled or curved towards the first end 12. In accordance with some concepts, the second end 13 can be provided in a number of shapes and sizes, and it is not required that the tip be tapered or curved.

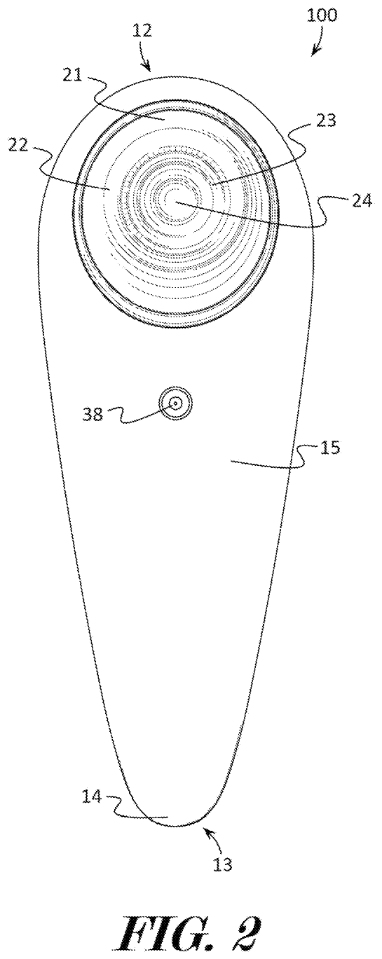

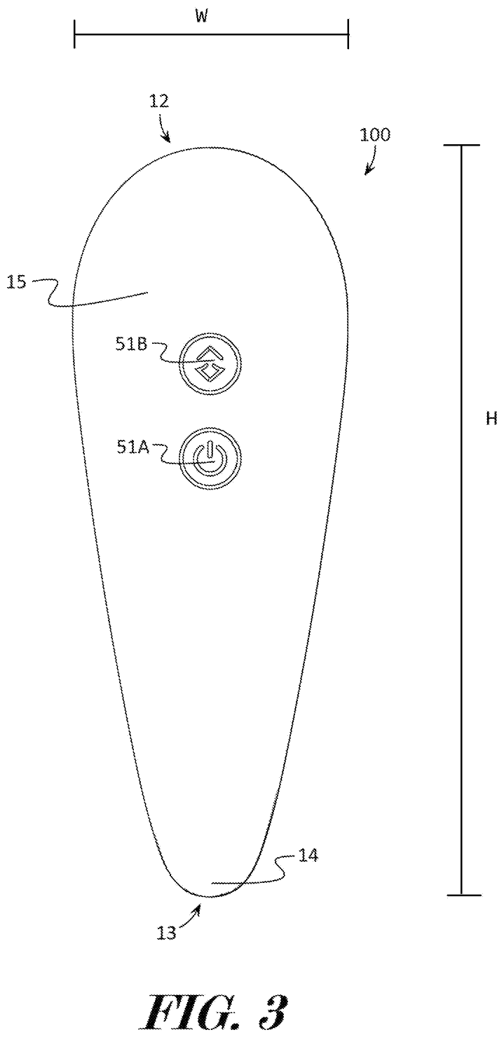

Turning to FIGS. 2 and 3, in some implementations housing 11 comprises a unitary piece, such that it does not contain any joints or articulating portions. In some implementations, for example, when the device is used to massage a clitoris, the device 100 can have a height H of about 8 inches or less, or about 7 inches or less, or about 6 inches or less, or about 5.5 inches or less, or in a range of about 5 to about 6 inches. In some aspects, the maximum width W and maximum depth D of the device at the vibrating head can be selected to accommodate the elements of the vibrating head. In some illustrative implementations, device 100 can have a maximum width W of about 3 inches or less, or about 2.5 inches or less, or about 2 inches, or in a range of about 2 inches to about 3 inches. In some implementations, device 100 can have a maximum depth D measured at the vibrating head of about 2.25 inches or less, or about 1.5 to about 2.5 inches, or about 2 inches to about 2.3 inches. In some implementations, the widest portion of the device 100 is at a location between the first end 12 and second end 13, and in some aspects, the widest portion of the device 100 is across the vibrating head 21. In some implementations, devices 100 may have a low profile that is easily manipulated by a user.

The device 100 is sized to comfortably fit into a user's hand. The device is provided as a lightweight personal massage device, to minimize hand fatigue during use. For example, the device can weigh less than a pound, or less than 0.5 pounds, or less than 7 ounces, or less than 6 ounces, or less than 5 ounces, or in a range of about 5 ounces to about 8 ounces. In some aspects, the device is ergonomically shaped such that it seats comfortably in a user's hand and is easily applied to the tissue to be treated by massage.

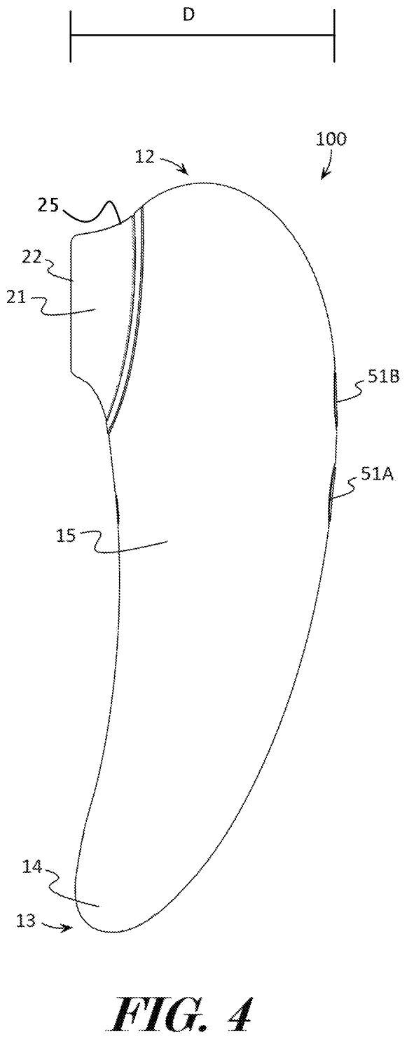

The housing 11 can include control inputs 51A and 51B at any suitable location. One convenient location is illustrated in FIGS. 3 and 4, wherein control inputs 51A and 51B are positioned at an opposite side of the device 100 from the vibrating head 21. In some implementations, control inputs 51A and 51B are provided at a location that is convenient for the user and avoids unintended activation of the inputs during use. Thus, control inputs 51A and 51B can be provided near the second end 13, on the side of the device containing the vibrating head 21, along a side of the device 100, and the like.

A housing 11 may be made from or may comprise a substantially rigid material, such as various types of hard plastics, including but not limited to polyethylene (PE), Ultra-high-molecular-weight polyethylene (UHMWPE, UHMW), polypropylene (PP), and polyvinyl chloride (PVC), polycarbonate, nylon, Poly(methyl methacrylate) (PMMA) also known as acrylic, melamine, steel alloys, aluminum, aluminum alloys, copper alloys, other types of metal or metal alloys, hard rubbers, fiberglass, carbon, or any other material including combinations of materials that are substantially rigid and suitable for securing and positioning the other elements of the device 100. It should be appreciated that in some implementations, the housing 11 can be made of flexible materials, such as a malleable metal or metal alloy, which can be subject to repeated deformations.

In some implementations, the device 100 may comprise a flexible cover 15 which may be positioned over all or portions of the housing 11 and which may provide a soft and flexible surface that is favored by human touch. A flexible cover 15 may also function as a water-tight seal for portions of the housing 11, such as to prevent water and other liquids from entering any seams between one or more sections of the housing that may result during the manufacturing process. In some implementations, a flexible cover 15 may be made from or comprise a resilient material such as silicone foams, rubber foams, silicone rubber, more In some implementations medical grade silicone, urethane foams including plastic foams, neoprene foam, latex foam rubber, polyurethane foam rubber, or elastomer materials such as elastic plastics, elastic silicone, elastic rubbers, or any other elastomer or resilient material, including combinations of materials, that is suitable for prolonged contact with human skin.

Turning to FIG. 4, the device 100 may comprise a vibrating head 21 which may be coupled to the housing 11 below the first end 12. In some implementations, a vibrating head 21 extends away from the housing 11 in a direction generally perpendicular to the elongated shape of the housing 11. Optionally, the tapered tip 14 of the second end 13 may be angled or curved towards the vibrating head 21. In accordance with some implementations, the vibrating head 21 can comprise annular projection 22, annular depression 23, and convex projection 24. Optionally, vibrating head further comprises an annular buttress 25. In some aspects, the vibrating head 21 is coupled to the housing 11 in a manner such that each of the annular projection 22, annular depression 23, convex projection 24, and annular buttress 25 (when included) are located external to, and extend in a generally perpendicular direction away from, the housing 11. In these aspects, no portion of the vibrating head 21 extends into the interior space 18 of housing 11. In some aspects, the vibrating head 21 can be coupled to the housing 11 in a manner such that the annular projection 22, annular depression 23, convex projection 24, and annular buttress 25 (when included) are substantially flush with the surface of the housing 11. The distance vibrating head 21 extends from the housing 11 can be selected depending upon the application of the device.

A vibrating head 21 may be made from or may comprise resilient material including but not limited to silicone foams, rubber foams, silicone rubber, medical grade silicone, urethane foams including plastic foams, neoprene foam, latex foam rubber, polyurethane foam rubber, or elastomer materials such as elastic plastics, elastic silicone, elastic rubbers, or any other elastomer or resilient material, including combinations of materials, that is suitable for prolonged contact with human skin.

The vibrating head 21 may comprise an annular projection 22 which may extend generally perpendicularly away from the housing 11. In some implementations, an annular projection 22 may comprise a generally ring-shaped ridge that may extend away from the housing 11. In some aspects, an annular projection may be configured in any shape and size. One illustrative height of the annular projection (measured from the housing 11) is up to about 2 cm, or in a range of about 14 to about 18 mm, or in a range of about 15 to about 16 mm. In some implementations, an annular projection 22 is not used.

In accordance with some concepts, vibrating head 21 can comprise an annular depression 23 that may be positioned within the annular projection 22 and depressed below the annular projection 22. An annular depression 23 may be depressed below the annular projection 22 by having the portions of the vibrating head 21 that form the annular depression 23 positioned closer to the housing 11 than the portions of the vibrating head 21 that form the annular projection 22. In some implementations, an annular depression 23 and annular projection 22 may be generally concentric with each other. In some implementations, portions of the annular depression 23 that are proximate to the annular projection 22 may be depressed below the annular projection 22 a greater distance than portions of the annular depression 23 that are proximate to the convex projection 24 as perhaps best shown in FIG. 8. In some implementations, annular depression 23 can be depressed below the annular projection 24 a maximum length that is approximately ⅓ the height of the annular projection 24. For example, when the annular projection 22 has a height of about 15 mm, annular depression 23 can be depressed below the annular projection about 5 mm, when measured at its maximum depth proximate to the annular projection 22. In some implementations, the annular depression 23 is not used.

In some implementations, the vibrating head 21 may comprise a convex projection 24. In some implementations, the convex projection 24 may be positioned within the annular depression 23, and the convex projection 24 may extend above the annular depression 23. A convex projection 24 may extend above the annular depression 23 by having the portions of the vibrating head 21 that form the convex projection 24 being positioned farther from the housing 11 than the portions of the vibrating head 21 that form the annular depression 23. In some implementations, a convex projection 24 may be generally circular and convex (relative to the housing 11) in shape. In some aspects, an annular projection 22, annular depression 23 and convex projection 24 may be concentric with each other. In some implementations, an annular depression 23 is not included, and in these aspects, the convex projection 24 may extend from the housing 11 a distance that is equal to, less than, or more than, the distance the annular projection 22. The relative size and position of the convex projection 24 and annular projection 22 can be selected depending upon the massage application.

In some implementations, a convex projection 24 may be configured in any shape and size. For example, convex projection 24 can be circular, square, triangular, or any other desired shape. In some implementations, the convex projection 24 can have a height measured from the annular depression of about 2 mm. Thus, in some implementations, when not in use and when viewed from the side, convex projection 24 is not visible but is seated inside the annular projection 22 as illustrated in FIGS. 4 and 8 for example. In some implementations, the convex projection 24 can be used without the annular projection 22 and the annular depression 23.

Referring to FIG. 8, the vibrating head 21 may comprise an annular buttress 25 which may be used to movably couple the annular projection 22 to the housing 11 and/or flexible cover 15. Optionally, the device 100 may comprise a head ring 16 which may be coupled to the housing 11, and an annular buttress 25 may be coupled to the head ring 16, and therefore to the housing 11, via a tongue 27 in the vibrating head 21 and groove 17 in the head ring 16 that may be press fit or frictionally coupled together, although any other suitable coupling method may be used. In some implementations, an annular buttress 25 may be formed with a relatively thicker amount of resilient material than portions of the vibrating head 21 that form the annular depression 23 so that the annular buttress 25 may be relatively less flexible than the portions of the vibrating head 21 that form the annular projection 22 and/or annular depression 23. In some implementations, the thickness of annular buttress 25 varies around its circumference.

In some implementations, vibrating head 21 is sized and configured to provide clitoral massage. Generally, the glans of the clitoris can have a transverse diameter of about 2.5 to about 4.5 mm, and a longitudinal diameter of about 3.5 to about 6.5 mm. In some implementations, the convex projection 24 is the portion of the vibrating head 21 that primarily contacts the glans of the clitoris. In illustrative implementations, dimensions of the convex projection 24 can be larger than the average dimensions of a clitoris, for example, the convex projection 24 can have a diameter up to about 1 cm, or in a range of about 7 cm to about 10 mm, or in a range of about 8 to about 9 mm. In other implementations, multiple parts of the vibrating head 21 can contact the user, such as the convex projection 24 and the annular depression 23. In these aspects, the dimensions of both of these components can be taken into consideration when determining a desired configuration.

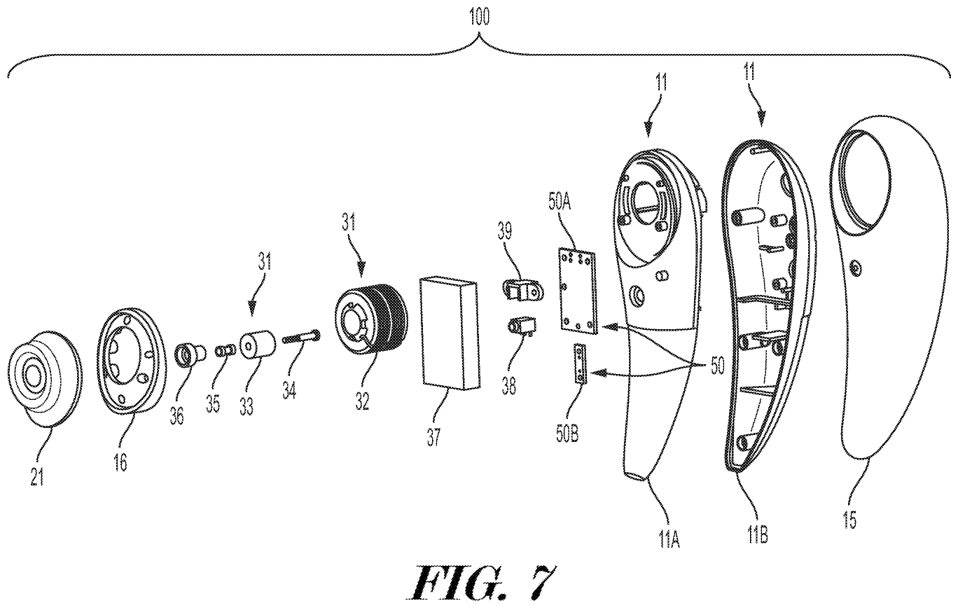

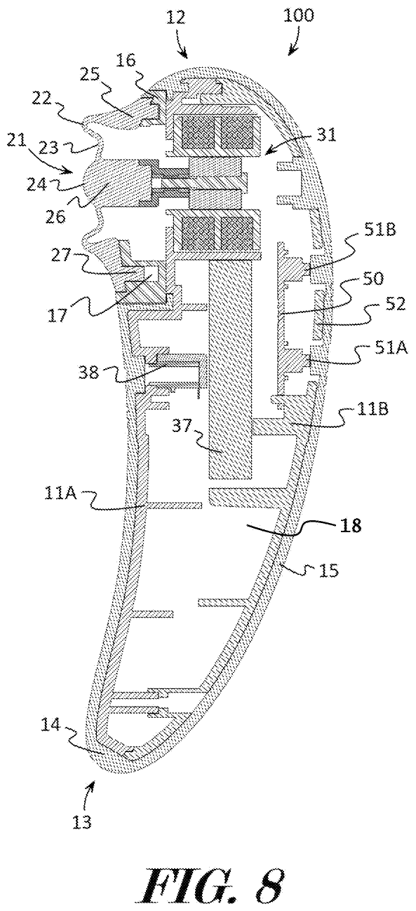

As illustrated in FIGS. 7 and 8, housing 11 defines an interior space 18 that can contain operational components of the device 100, such as the motor 31, power source 37, control unit 50, and the like. Optionally, a housing 11 may comprise one or more housing subunits 11A, 11B, which may be formed or molded separately and then coupled together with elements, such as a motor 31, control unit 50, etc., positioned between the housing subunits 11A, 11B and thus within the interior space 18 of the housing 11. A motor 31 may be coupled to the vibrating head 21 and the motor 31 may be operable to cause the vibrating head 21 to vibrate. A control unit 50 may be configured to control the motor 31 to generate a number of vibration patterns, and one or more control inputs 51A, 51B, may be manipulated by a user to provide input to the control unit 50 for selecting a desired vibration pattern.

In some implementations, the device 100 may comprise a projection shaft 26 which may be coupled to the convex projection 24 and operatively coupled to a motor 31 so that vibrations produced by the motor 31 may be communicated along a vibration axis to the convex projection 24 via the projection shaft 26. In some implementations, a projection shaft 26 may be formed with a relatively thicker amount of resilient material than portions of the vibrating head 21 that form the annular depression 23 and the annular buttress 25 so that the projection shaft 26 may be relatively less flexible than the portions of the vibrating head 21 that form the annular projection 22, annular depression 23 and/or annular buttress 25. In some implementations, a projection shaft 26 may be generally cylindrical in shape, while in other implementations, a projection shaft 26 may be configured in any shape and size. Optionally, the projection shaft 24 can be provided in the same shape as the convex projection 24. In some implementations, the diameter of the projection shaft 26 is equal to the diameter of the convex projection 24. In these aspects, vibrational force from the motor 31 can be evenly applied to the convex projection 24. This can provide a more comfortable, human-like touch. In some implementations, the diameter of the projection shaft 26 may be smaller or greater than the diameter of the convex projection 24. In some implementations, a projection shaft 26 may be made from a flexible material that may be used to form other elements of the vibrating head 21 or any other suitable material.

Optionally, projection shaft can have an adjustable length, so that the overall device can provide adjustable stroke length. In some aspects, projection shaft 26 can comprise a telescoping shaft. That is, the projection shaft can comprise segments that slide within one another, with a design that is similar to tubes of a jointed telescope or extendable antenna. Coaxially telescoping projection shaft can allow the length of the projection shaft to be adjusted to be longer or shorter, depending upon the desired stroke length (e.g., distance the convex projection will travel). Other adjustable configurations can be used within the scope of the disclosure concepts. In some implementations, the adjustable configurations are user adjustable.

In some implementations, a convex projection 24 and an annular buttress 25 may form the only portions of the vibrating head 21 that may be coupled to the housing 11 and motor 31 so that the annular depression 23 and portions of the annular projection 22 proximate to the annular depression 23 may be the most flexible portions of the vibrating head 21. As illustrated in FIG. 8, in some implementations, the annular depression 23 is thus a floating surface within the vibrating head 21, in that the annular depression is not directly coupled to, or supported by, the housing 11 or motor 31. In some aspects, this can allow an optimized movement of the convex projection 24 while providing a soft and adjustable profile at other portions of the vibrating head that may contact the user. As illustrated in FIGS. 9 and 10, the floating nature of the annular depression also allows for variation in touch profile during use.

In accordance with some implementations, projection shaft 26 transfers a vibration motion of the motor 31 to the convex projection 24 of vibrating head 21. Thus, when the motor 31 is activated, the projection shaft 26 is driven in a lateral direction along a vibration axis A, causing linear oscillation of the convex projection 24 in a manner that provides massage to the user. As shown in FIGS. 9 and 10, portions of the vibrating head 21 can extend in a direction A perpendicular to the housing 11 so that the convex projection 24 contacts the tissue to be treated, such as a clitoris. In this manner, components of the vibrating head 21 extend to contact the tissue, as compared to vacuum devices that form a seal around the tissue to be treated (e.g., clitoris). Because portions of the vibrating head 21 move in this oscillating manner perpendicular to the housing 11, the device extends to touch the clitoris, as opposed to drawing the tissue into a vacuum or simply blowing air in the direction of the clitoris. Accordingly, some devices can provide many advantages, including allowing natural tissue fluids to remain at the clitoris (thus avoiding drying effects when a device uses air movement), and simulation of natural human touch, which can enhance the massage experience. The relative size and spacing of the components of the vibrating head 21 can be selected to provide a desired massage pattern and touch profile.

As illustrated in FIG. 9, one mode of vibration of the device can be activated, wherein the motor 31 drives projection shaft 26 to linearly oscillate along a vibration axis A, which in turn causes convex projection 24 to move forward a stroke length S. As shown, convex projection 24 has a starting (resting) position shown in broken lines, from which it extends in a lateral direction beyond annular projection 22 to contact the tissue to be treated (e.g., a clitoris). In accordance with these aspects, convex projection 24 can extend a distance beyond the annular projection equal to (or less than) the height of the convex projection 24 measured from the annular depression 23. In some implementations, this distance can be 5 mm or less, or 4 mm or less, or 3 mm or less, or 2 mm or less, or 1 mm or less, as desired. In these implementations, the touch profile 24a created by extension of the convex projection comprises a rounded protrusion that extends beyond the annular projection 22.

Another mode of vibration is illustrated in FIG. 10, wherein motor 31 causes projection shaft 26 to linearly oscillate, which in turn causes the convex projection 24 and annular depression 23 to extend along vibration axis (A) to a point beyond the annular projection 22 to contact the tissue to be treated. Convex projection 24 travels along vibration axis A for a stroke length S. In accordance with these aspects, both the convex projection 24 and annular depression 23 extend beyond the annular projection 22 during use. In the illustrated implementation, the touch profile 24b comprises a rounded tip having a shoulder, wherein the shoulder is formed by extension of the annular depression 23 beyond the annular projection 22.

Some concepts thus allow the user to change the touch profile of the device by simply activating a control input of the device. This can be a significant advantage, as the device provides more variety of massage without requiring additional components.

The distance the convex projection 24 can extend beyond the annular projection 22 can be, for example, 1 cm or less, or 9 mm or less, or 8 mm or less, or 7 mm or less, or 6 mm or less. The stroke length S, measured as the distance convex projection 24 travels from its resting position (represented by broken lines in FIGS. 9 and 10) to its fully extended position, can thus be 12 mm or less, or 11 mm or less, or 10 mm or less, or 9 mm or less, or 8 mm or less. In some implementations, devices can provide a variety of predetermined stroke length options to a user. The distance the convex projection 24 travels (and thus to total stroke length S) can depend upon such factors as the dimensions of the vibrating head 21 components (annular projection 22, annular depression 23, and convex projection 24), the length of the projection shaft 26, flexibility of annular depression 23, and the length of the components coupling the projection shaft 26 to the motor 31, for example.

In some implementations, vibrating head 21 can be preconfigured in a desired touch profile. For example, vibrating head 21 can be configured to have touch profile 24a so that the device presents this configuration both at rest and in use. In this manner, the convex projection 24 is positioned beyond annular projection 22 prior to activating the motor 31. In these aspects, vibrating head 21 of the device 100 comprises annular projection 22, annular depression 23, and convex projection 24, wherein the annular depression 23 is positioned farther from the housing 11 than the portions of the vibrating head 21 that form the annular projection 22. Likewise, vibrating head 21 can be configured to have touch profile 24b so that the device presents this configuration both at rest and in use. In these aspects, vibrating head 21 of the device 100 comprises annular projection 22, annular depression 23, and convex projection 24, wherein both the annular depression 23 and convex projection 24 are positioned farther from the housing 11 than the portions of the vibrating head 21 that form the annular projection 22.

The device 100 may comprise a motor 31 which may be operable to cause the vibrating head 21 to linearly oscillate. In some implementations, a motor 31 may comprise a coil 32 and magnet 33, and the magnet 33 may be motivated to vibrate by the applying electricity to the coil 32. In further implementations, a motor 31 may comprise a brushed DC motor, brushless DC motor, switched reluctance motor, universal motor, or any other electrically operated motor that may be used to generate vibrations. In some implementations, the device 100 may comprise a motor 31 which may be operable to cause the vibrating head 21 to oscillate along different axis. For example, in some implementations, the device 100 may comprise a motor 31 which may be operable to cause the vibrating head 21 to provide random orbital oscillations.

In some implementations, a motor 31 may be operatively coupled to a projection shaft 26 of a vibrating head 21 via a bolt 34 and nut 35, or other type of fastener or fastening method, and a spacer 36 may then couple the projection shaft 26 to the motor 31 via the bolt 34 and nut 35. In other implementations, any other coupling method may be used to operatively couple a motor 31 to a vibrating head 21.

A control unit 50 may be configured to control the motor 31 to generate a number of vibration patterns. For example, a vibration pattern can present a constant rate of vibration, or an intermittent, or pulsed vibration. In some implementations, a control unit 50 may comprise one or more circuit boards 50A, 50B, such as a printed circuit board (PCB) which mechanically supports and electrically connects electronic components using conductive tracks, pads and other features etched from copper sheets laminated onto a non-conductive substrate. PCBs can be single sided (one copper layer), double sided (two copper layers) or multi-layer. Conductors on different layers may be connected with plated-through holes called vias. In some implementations, a circuit board 50A, 50B, may only comprise copper connections and no embedded components and may be called a printed wiring board (PWB) or etched wiring board. In other implementations, a circuit board 50A, 50B, may comprise a printed circuit assembly (PCA), printed circuit board assembly or PCB assembly (PCBA), a circuit card assembly (CCA), or a backplane assembly, or any other suitable electrical connection and communication method including standard wiring and the like.

In further implementations, a control unit 50 may comprise or integrate one or more components on a single chip sometimes called a system on a chip (SoC) or system on chip (SOC). In still further implementations, a control unit 50 may comprise a microcontroller (or MCU, short for microcontroller unit) which may be a small computer (SoC) on a single integrated circuit containing a processor, memory, and programmable input/output interfaces or control inputs 51. Program memory in the form of Ferroelectric RAM, NOR flash or OTP ROM is also often included on chip, as well as a typically small amount of RAM. Microcontrollers are designed for embedded applications, in contrast to the microprocessors used in personal computers or other general-purpose applications consisting of various discrete chips. Microcontrollers are used in automatically controlled products and devices, such as automobile engine control systems, implantable medical devices, remote controls, office machines, appliances, power tools, toys and other embedded systems. By reducing the size and cost compared to a design that uses a separate microprocessor, memory, and input/output devices, microcontrollers make it economical to digitally control even more devices and processes. Mixed signal microcontrollers are common, integrating analog components needed to control non-digital electronic systems.

In some implementations, the device 100 may comprise one or more control inputs 51A, 51B, that can be manipulated by a user to provide input to the control unit 50 for selecting a desired vibration pattern. In some implementations, one or more control inputs 51A, 51B, may comprise press-able buttons or switches. In other implementations, a control input 51A, 51B, may comprise any other type of user interface, such as rocker type switches, toggle switches, dials, and the like. In some implementations, control inputs 51A and 51B are low profile interfaces, so that the device 100 provides an overall smooth profile. Optionally, a device 100 may comprise a first control input 51A which may be operable to turn the device 100 on and off and a second control input 51B which may be operable to allow the user to select a desired vibration pattern. In other implementations, a single control input 51A, 51B, may be configured to provide input to a control unit 50 to both turn the device 100 on and off and to select a desired vibration pattern. In some implementations, the vibration pattern can be manipulated with respect to speed (strokes, or “taps” per minute), amplitude (direction of travel along vibration axis A, in mm), and pattern (a steady state vibration, or a patterned vibration that varies).

In some implementations, the device 100 provides adjustable speed, so that the user can choose the desired strokes (taps) per minute. Optionally, the control input allows the user to select a desired speed of about 180 strokes per minute, or about 240 strokes per minute, or about 360 strokes per minute, or 720 strokes per minute, or 1,000 strokes per minute, or 2,000 strokes per minute, or 3,000 strokes per minute, or 3,500 strokes per minute. The vibration can be in a constant rate or a pulsed rate (for example, a desired revolutions per second, followed by a pause).

Optionally, a heating element can be included in the massage device 100 for providing heat to the vibrating head 21 or a portion thereof. The heating element can be powered by the power source 37. A control input can be used to turn the heat on or off and can be incorporated into a control input for turn the device on and off and/or to select a desired vibration pattern. The heating element can be provided directly beneath the vibrating head 21 and can be composed of resistive elements that contain temperature protection circuitry. In some implementations, the heating element comprises an annular heating element that surrounds or is otherwise in contact with the portion of the device that will be in contact with the clitoris. The heating element can provide gentle heat to portions of the device that will contact the site of massage, yet remain relatively cool to the touch at other areas of the device.

In some implementations, annular projection 22 can contact a user (in addition to the convex projection and/or annular depression). Such contact can be at the direct site of massage (e.g., clitoris), or at surrounding tissues. The amount of pressure a user applies to the device against the tissue to be treated may impact whether and how the annular projection 22 contacts the user. Optionally, a heating element can be included as an annular ring in contact with the annular projection.

In some implementations, a control input 51A, 51B, housing 11, or other element, may comprise or be in communication with a light emitting element 52, such as a light emitting diode (LED) which may be configured to provide light of various wavelengths and intensities in response to input provided via a control input 51A, 51B, and/or to visually appraise a user on the status of the device 100, such as being powered on, charging, etc.

In some implementations, the device 100 may comprise a power source 37 which may provide electrical power to any component that may require electrical power. A power source 37 may comprise a battery, such as a lithium-ion battery, nickel cadmium battery, alkaline battery, or any other suitable type of battery, a fuel cell, a capacitor, a super capacitor, or any other type of energy storing and/or electricity releasing device. In further implementations, a power source 37 may comprise a power cord, kinetic or piezo electric battery charging device, and/or inductive charging or wireless power receiver.

In some implementations, the device 100 may comprise a power input plug member 38 which may be configured to mate with a complementary external plug member which may be configured to supply electrical power to the device 100. Optionally, a power input plug member 38 may be coupled to the housing 11 via a plug retainer 39 which may structurally reinforce the power input plug member 38. The power input plug member 38 may be in electrical communication with the power source 37. Once the power input plug member 38 is mated with a complementary external plug member, electrical power may be communicated from the external plug member, through the power input plug member 38, and to the power source 37 thereby allowing the power source 37 to be charged or recharged by the external plug member. A power input plug member 38 may comprise a USB connector such as a female micro-USB or female mini-USB, a Type C USB plug, a coaxial power connector plug, a barrel connector plug, a concentric barrel connector plug, a tip connector plug, or any other plug, connector, or receptacle capable of enabling electrical communication.

While some example shapes and sizes have been provided for elements of the device 100, it should be understood to one of ordinary skill in the art that the housing 11, vibrating head 21, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the disclosure. It is understood that the terms and proposed shapes used herein are merely descriptive, rather than limiting, and that various changes, such as to size and shape, may be made without departing from the spirit or scope of the disclosure.

Additionally, while some materials have been provided, in other implementations, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some implementations, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other implementations, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further implementations, one or more of the elements that comprise the device 100 may be coupled by being one of connected to and integrally formed with another element of the device 100.

The terminology used herein is for the purpose of describing particular implementations only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the disclosure and the claims.

For purposes of description herein, the terms “upper,” “lower,” “left,” “right,” “rear,” “front,” “side,” “vertical,” “horizontal,” and derivatives thereof shall relate to the disclosure as oriented in FIG. 1. However, one will understand that the disclosure may assume various alternative orientations and step sequences, except where expressly specified to the contrary. Therefore, the specific devices and processes illustrated in the attached drawings, and described in the following specification, are simply exemplary implementations of some concepts defined in the appended claims. Hence, specific dimensions and other physical characteristics relating to the implementations disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the disclosure.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Although the present disclosure has been illustrated and described herein with reference to some implementations and specific examples thereof, it will be readily apparent to those of ordinary skill in the art that other implementations and examples may perform similar functions and/or achieve like results. All such equivalent implementations and examples are within the spirit and scope of the present disclosure, are contemplated thereby, and are intended to be covered by the following claims.

What is claimed is:

1. A personal massage device comprising:
an elongated housing having a first end and a second end, wherein the second end is configured with a tapered tip that is curved towards the first end;
a vibrating head coupled to the housing below the first end;
an annular projection formed in the vibrating head that extends away from the housing relative to the first and second ends;
an annular depression positioned within the annular projection and depressed below the annular projection;
a convex projection positioned within the annular depression and extending above the annular depression;
a motor coupled to the convex projection, the motor operable to cause the convex projection to linearly oscillate along a vibration axis; and
a control unit configured to operate the motor to generate a number of vibration patterns.

2. The personal massage device of claim 1 wherein the annular projection extends away from the housing in a perpendicular direction relative to the first and second ends.

3. The personal massage device of claim 1 wherein the annular projection, annular depression, and convex projection are concentric.

4. The personal massage device of claim 1 wherein the vibrating head further comprises an annular buttress.

5. The personal massage device of claim 4 further comprising a head ring that couples the annular buttress to the housing.

6. The personal massage device of claim 5 wherein the convex projection and the annular buttress form the only portions of the vibrating head that are coupled to the housing and motor.

7. The personal massage device of claim 1 wherein the convex projection is configured to massage a clitoris.

8. The personal massage device of claim 1 further comprising a projection shaft that couples the motor to the convex projection.

9. The personal massage device of claim 8 wherein the projection shaft and the convex projection have equal diameters.

10. The personal massage device of claim 1 wherein the housing includes an interior space, and the vibrating head does not extend into the interior space.

11. The personal massage device of claim 1 further comprising a flexible cover.

12. A personal massage device comprising:
an elongated housing having a first end and a second end;
a vibrating head coupled to the housing below the first end, the vibrating head comprising an annular projection that extends away from the housing relative to the first and second ends, an annular depression positioned within the annular projection and depressed below the annular projection, and a convex projection positioned within the annular depression and extending above the annular depression;
a motor coupled to the convex projection of the vibrating head so as to cause the convex projection to extend along a vibration axis to a position that is beyond the annular projection; and
a control unit configured to operate the motor to generate a number of vibration patterns.

13. The personal massage device of claim 12 further comprising one or more control inputs configured to be manipulated by a user to provide input to the control unit for selecting a desired vibration pattern.

14. The personal massage device of claim 12 wherein the annular projection, annular depression, and convex projection are concentric.

15. The personal massage device of claim 12 wherein the vibrating head further comprises an annular buttress.

16. The personal massage device of claim 12 wherein the convex projection is configured to massage a clitoris.

17. The personal massage device of claim 12 further comprising a projection shaft that couples the motor to the convex projection.

18. The personal massage device of claim 17 wherein the vibrating head can provide more than one touch profile to massage a tissue.

19. The personal massage device of claim 12 wherein the housing includes an interior space, and the vibrating head does not extend into the interior space.

20. A personal massage device comprising:
an elongated housing having a first end and a second end;
a vibrating head coupled to the housing below the first end, the vibrating head comprising an annular projection that extends away from the housing relative to the first and second ends and a convex projection positioned within the annular projection;
a motor coupled to the convex projection of the vibrating head so as to cause the convex projection to extend along a vibration axis; and
a control unit configured to operate the motor to generate a number of vibration patterns.
